(19) United States
(12) Patent Application Publication
(10) Pub. No.: US 2008/0091736 A1
(43) Pub. Date: Apr. 17, 2008

(54) DATA MANAGEMENT SYSTEM AND DATA MANAGEMENT METHOD

(75) Inventors: Kazumi Sawayanagi, Itami-shi (JP); Yoshiyuki Tamai, Itami-shi (JP); Takeshi Minami, Amagasaki-shi (JP); Hidetaka Iwai, Itami-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/871,283

(22) Filed: Oct. 12, 2007

(30) Foreign Application Priority Data
Oct. 13, 2006 (JP) 2006-280226

(51) Int. Cl. G06F 17/30

(52) U.S. Cl. 707/200; 707/E17.005

(57) ABSTRACT

A data management system for encrypting management object data and storing the encrypted management object data, and for outputting the management object data, the data management system comprising: an output abnormality detection part for detecting an output abnormality occurring in a terminal device specified for outputting the management object data; a proxy destination determination part for, when the output abnormality detection part detects the output abnormality, determining a proxy processing terminal device from among the plurality of terminal devices, the proxy processing terminal device being for outputting the stored management object data instead of the terminal device having the output abnormality; and a decryption/encryption part for, when the proxy destination determination part has determined the proxy processing terminal device, decrypting encrypted management object data that has been generated by encrypting the management object data, and further encrypting the resultant decrypted management object data that is decryptable by the proxy processing terminal device.

This application is based on application No. 2006-280226 filed in Japan, the contents of which are hereby incorporated by reference.

### BACKGROUND OF THE INVENTION

(1) Field of the Invention

The present invention relates to a data management system and a data management method, and more particularly to a technique for managing data confidentially.

(2) Description of the Related Art

In recent years, there have been data management systems that manage data confidentially among a plurality of terminal devices that are connected to a network. For example, there is a construction in which a security code, device identification information and the like are added to management data, so that data output is allowed only when the information matches the information held by an output destination.

Also, management data may be encrypted in a manner that only a predetermined terminal device that is specified as the output destination can decrypt it. If such a construction is adopted, only the user who can use the above-described predetermined terminal device can output the encrypted data, which results in higher confidentiality of the data.

However, with the above-described construction, the above-described terminal device cannot be replaced by another terminal device for a data output in the event of a failure in the output part of the above-described terminal device, or in the event of the long job waiting time thereof. This is because the data that is encrypted in a manner that only the above-described predetermined terminal device can decrypt cannot be decrypted by other terminal devices, and yet, if the encrypted data is transferred to another terminal device after having been decrypted by the above described predetermined terminal device, the level of the confidentiality of the data deteriorates.

Also, if the above-described predetermined terminal device is removed from the data management system due to the replacement of the terminal device and such, the data that can be decrypted only by the above-described predetermined terminal device may never be output.

### SUMMARY OF THE INVENTION

The object of the present invention is therefore to provide a data management system and a data management method that can output encrypted data while maintaining the confidentiality even when output abnormality occurs in a predetermined terminal device specified as the output destination.

To achieve the above-described object, a data management system according to one construction of the present invention is a data management system in which a plurality of terminal devices are connected via a network, the data management system being for encrypting management object data and storing the encrypted management object data, and for outputting the management object data from an output part of any one of the plurality of terminal devices that is capable of decryption, the data management system comprising: an output abnormality detection part for detecting an output abnormality occurring in the any one of the terminal devices specified for outputting the management object data; a proxy destination determination part for, when the output abnormality detection part detects the output abnormality, determining a proxy processing terminal device from among the plurality of terminal devices, the proxy processing terminal device being for outputting the stored management object data instead of the terminal device having the output abnormality; and a decryption/encryption part for, when the proxy destination determination part has determined the proxy processing terminal device, decrypting the encrypted management object data that has been generated by encrypting the management object data, and further encrypting the resultant decrypted management object data to obtain resultant encrypted management data that is decryptable by the proxy processing terminal device.

Also, a data management system according to one construction of the present invention is a data management system in which a plurality of terminal devices are connected via a network, the data management system being for encrypting management object data and storing the encrypted management object data, and for outputting the management object data from an output part of any one of the plurality of terminal devices that is capable of decryption, the data management system comprising: an output destination change reception part for receiving an instruction to change a terminal device specified as an output destination of the management object data; and a decryption/encryption part for, when the output destination change reception part has received the instruction to change the terminal device, decrypting the encrypted management object data that has been encrypted in a manner that the terminal, device specified as an original output destination can decrypt the management object data, and further encrypting the resultant decrypted management object data to obtain resultant encrypted management object data that is decryptable by a terminal device specified as a new output destination.

A data management method according to one construction of the present invention is a method of data management for encrypting management object data and storing the encrypted management object data, and for outputting the management object data from an output part of any one of the plurality of terminal devices that is capable of decryption, in a data management system in which the plurality of terminal devices are connected via a network, comprising the steps of: detecting an output abnormality occurring in the any one of the terminal devices specified for outputting the management object data; determining, when the output abnormality has been detected, a proxy processing terminal device from among the plurality of terminal devices instead of the terminal device having the output abnormality, the proxy processing terminal device being for outputting the management object data; decrypting, when the proxy processing terminal device has been determined, the encrypted management object data that has been generated by encrypting the management object data, and further encrypting the resultant decrypted management object data to obtain resultant encrypted management object data that is decryptable by the proxy processing terminal device.

Also, a data management method according to one construction of the present invention is a method of data management for encrypting management object data and storing the encrypted management object data, and for outputting the management object data from an output part of any one of the plurality of terminal devices that is capable of decryption, in a data management system in which the plurality of terminal devices are connected via a network, comprising the steps of: receiving an instruction to change the terminal device specified as an output destination of the management object data; and, decrypting, when the instruction to change the terminal device has been received, the encrypted management object data that has been encrypted in a manner that the terminal device specified as an original output destination can decrypt the management object data, and further encrypting the resultant decrypted management object data to obtain resultant encrypted management object data that is decryptable by a terminal device specified as a new output destination.

As a result, even though the data management system of the present invention has a construction in which management object data is managed by being encrypted in a manner that only the predetermined terminal device specified as the output destination can decrypt the encrypted management object data, the encrypted management object data can be output from another terminal device without deteriorating the level of the confidentiality of the data.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a schematic diagram showing the overall construction of the data management system of the first embodiment;

FIG. 2 is a block diagram showing the outline of the data management system configuration of the first embodiment;

FIG. 3 is a flow chart showing the content of the data, input processing of the first embodiment;

FIG. 4 is a flow chart showing the content of the data output processing of the first embodiment;

FIG. 5 is a sequence diagram showing the general outline of the proxy output processing of the first embodiment;

FIG. 6 is a flow chart showing the content of the operational behavior of a client MFP during the proxy output processing of the first embodiment;

FIG. 7 is a flow chart showing the content of the operational behavior of the management server during the proxy output processing of the first embodiment;

FIG. 8 is a flow chart showing the content of the proxy destination determination processing of the first embodiment;

FIG. 9 is a sequence diagram showing the general outline of the output destination change processing of the first embodiment;

FIG. 10 is a schematic diagram showing the overall construction of the data management system of the second embodiment;

FIG. 11 is a block diagram showing the outline of the MFP configuration of the second embodiment;

FIG. 12 is a flow chart showing the content of the data output processing of the second embodiment;

FIG. 13 is a sequence diagram showing the general outline of the proxy output processing of the second embodiment; and

FIG. 14 is a flow chart showing the content of the output destination change processing of the second embodiment.

### DESCRIPTION OF THE PREFERRED EMBODIMENT

The following describes a data management system and a data management method as a preferred embodiment according to one construction of the present invention, with reference to the attached drawings.

### First Embodiment

(Construction of the Data Management System)

The following is a detailed description of the construction of the data management system of the first embodiment.

1. Overall Construction of the Data Management System

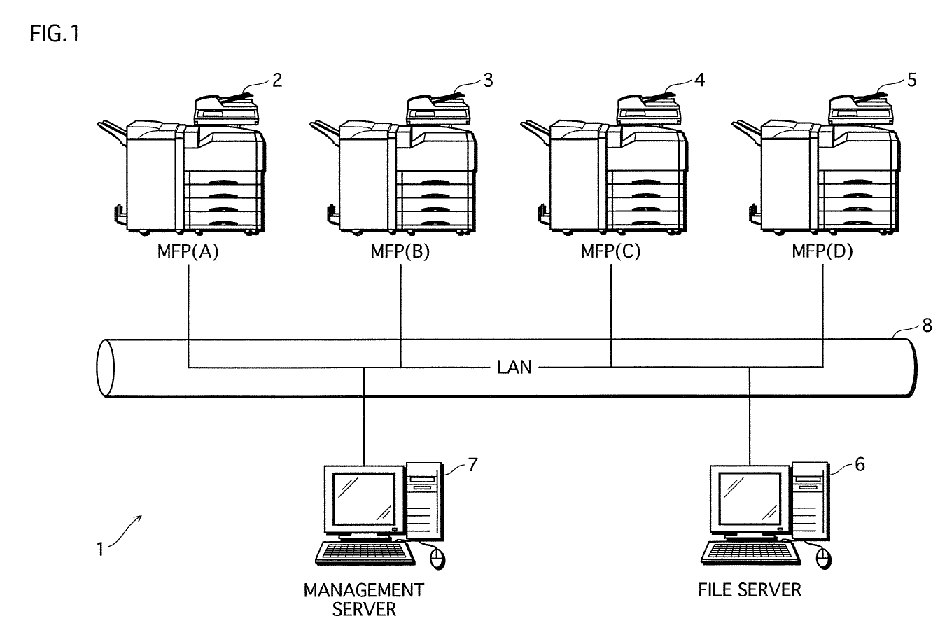

As shown in FIG. 1, the data management system 1 of the present embodiment includes MFPs (Multiple Function Peripheral) 2-5 as terminal devices, a file server 6 and a management server 7, which are each connected via a network 8.

2. Construction of the MFPs

The following are descriptions of the constructions and the functions of the MFPs 2-5 with the MFP 2 as an example.

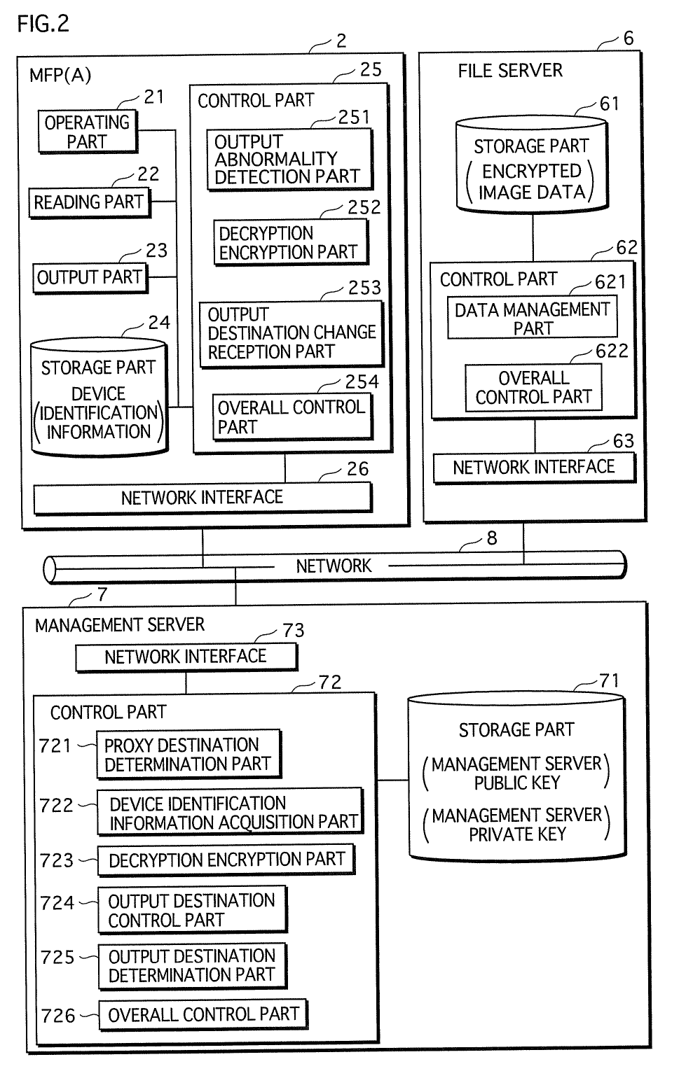

As shown in FIG. 2, the MFP 2 includes an operating part 21, a reading part 22, an output part 23, a storage part 24, a control part 25, and a network interface 26, as well as a CPU, a RAM and the like which are not shown in figures.

The operating part 21 includes a plurality of hard keys (not shown in figures) and a liquid crystal panel on which a touch sensor is attached (not shown in figures). Users input instructions to the MFP 2 by operating the plurality of hard keys and soft keys on the liquid crystal panel. The liquid crystal panel displays the job status of MFP 2 and the like.

Instructions input from the operating part can be divided into two types. The first type of the instructions is executed only by the MFP 2 such as an instruction for reading out image data from documents and an instruction for outputting the read image data. The second type of the instructions is executed as the whole data management system 1 such as an instruction for saving image data sent from the MFP 2 in the file server 6 and an instruction for outputting data saved in the file server 6 from one of the MFPs 25.

The reading part 22 scans document by moving a scanner (not shown in figures) equipped with an exposure lamp, converts the reflected light from the document faces, and reads out the image data from the documents. The read image data is first stored in the RAM and then may be output from the output part 23, or stored in the storage part 24, or sent to the file server 6 and the like via the network 8. It should be noted that, when image data is sent via the network 8, the image data is encrypted in order to secure the confidentiality of the data. A detailed description of the encryption is provided below.

The output part 23 is a printer part that prints out images corresponding to image data on sheets of paper, and the word “output” used in the present embodiment means “print out”. The output part 23 outputs image data upon receiving either an instruction that is input from an operating part of each of the MFPs 2-5 or an instruction that is sent from the management server 7.

The storage part 24 is a HHD (Hard Disk Drive) for example, and stores device identification information of the MFP 2.

Device identification information is information that can identify an MFP such as a serial number of a storage part, a serial number of an MFP, a public key, a MAC address, and an IP address. Image data to be output from the MFP 2 is encrypted based on the device identification information of the MFP 2.

In the present embodiment, device identification information unique to each MFP is particularly used as device identification information. For example, as the device identification information unique to the MFP 2, the serial number of the storage part 24 of the MFP 2, which is the number that only the MFP 2 has and cannot be acquired by other MFPs 3-5, is used. Device identification information unique to an MFP includes a serial number of an MFP, a public key, and a MAC address in addition to a serial number of a storage part.

The storage part 24 may store image data acquired by the reading part 22 of the MFP 2 and image data sent from either the file server 6 or the MFPs 3-5, in addition to the device identification information.

The control part 25 includes an output abnormality detection part 251, a decryption/encryption part 252, an output destination change reception part 253, and an overall control part 254. In the control part 25, functions of the parts 251-254 are performed when a program that is installed in a certain area secured in a storage medium of the computer system is read out on a RAM by the CPU to be executed, and cooperates with the OS (Operating System).

The output abnormality detection part 251 executes output abnormality detection processing to detect output abnormality of the MFP 2. Here, “the output abnormality” describes a state in which the output part 23 cannot output image data. Possible reasons why the output part 23 does not operate include a mechanical failure of the output part 23, the power of the MFP 2 being turned off and the like. Also, a case in which the output part 23 cannot start operating more than a predetermined time due to the accumulated jobs and such is considered to be the output abnormality. The output abnormality is determined by whether or not each member that constitutes the output part 23 work normally, whether or not the power is turned on, the whether or not jobs have accumulated to a predetermined extent, and the like.

The output abnormality detection processing is executed by the MFP 2, which is the output destination of image data. Upon receiving encrypted image data, with a data output instruction, the MFP 2 executes the output abnormality detection processing before decrypting the encrypted image data to determine whether or not the image data, can be output from the MFP 2. The result of the detection is sent from the MFP 2 to the management server 7 as the detection result information.

The output abnormality detection processing is also executed by the MFPs 3-5 in response to a request from the management server 7 during the proxy destination determination processing that is described below. A result of the detection is also sent from the MFPs 3-5 to the management server 7 as the detection result information.

The decryption/encryption part 252 encrypts image data and device identification information. Image data is encrypted when a user has selected to manage the image data confidentially. When the image data has been selected to be managed confidentially, device identification information is read out from the storage part 24 so that the image data can be encrypted based on the device identification information. The device identification information is encrypted when the device identification information is sent from the MFP 2 to the management server 7.

Image data is encrypted based on the device identification information regarding the MFP that is determined to be the output destination by a user. Therefore, the image data can be decrypted only by the MFP determined to be the output destination, and can only be output by the user who can use the MFP. For example, if the MFP used by the group to which a user belongs has been determined to be the output destination of a certain piece of image data, the MFPs used by other groups cannot output the image data.

Also, the decryption/encryption part 252 decrypts the image data that is encrypted (referred to as “encrypted image data” herein after). The encrypted image data that is encrypted with use of the device identification information unique to the MFP 2 can be decrypted only by the MFP 2 that has the device identification information, and cannot normally be decrypted by the other MFPs 3-5, the file server 6 and the management server 7. However, in the case of the management server 7 acquiring the device identification information during the proxy output processing that is described below, the management server 7 can also decrypt the encrypted image data.

Furthermore, during the output destination change processing which is executed when the output destination change reception part 253 receives an instruction for an output destination change, the decryption/encryption part 252 decrypts the image data that is encrypted in a manner that the MFP as the original output destination can decrypt, then further encrypts the decrypted image data in a manner that the MFP as the new output destination can decrypt. A detailed description of the output destination change processing is provided below.

The output destination change reception part 253 receives an instruction for changing the output destination of the image data to store in the data management system 1. The instruction is input by a user operating the operating part 21.

The overall control part 254 controls each of the parts 21-26 so that the MFP 2 operates smoothly as a whole.

The network interface 26 includes control programs such as a network communication program, and establishes the connections with other MFPs 3-5, the file server 6 and the management server 7 with use of a communication protocol so as to send and receive encrypted image data and such.

The descriptions of the MFPs 3-5 are omitted here since the constructions thereof are substantially the same as the MFP 2.

3. Construction of the File Server

The file server 6 includes a storage part 61, a control part 62, and a network interface 63 as well as a CPU, a RAM and the like which are not shown in figures.

The storage part 61 is an HDD to store the encrypted image data that is sent from the MFPs 2-5. The encrypted image data is stored in the storage part 61 after the ID information of the image data and the output destination information that shows the output destination of the image data are associated with the encrypted image data.

The control part 62 includes a data management part 621 and an overall control part 622. The control part 62 operates the functions of the parts 621 and 622 by a process in which a program that is installed in a certain area secured in a storage medium of the computer system is read out on a RAM by the CPU to be executed, and cooperates with the OS.

The data management part 621 stores encrypted image data sent from the MFPs in the storage part 61 in the data input processing. Also, upon receiving the instruction for transferring encrypted image data from the output destination MFP in the data output processing, the data management part 621 searches the encrypted image data and sends it to the output destination MFP. Specifically, the data management part 621 searches the target encrypted image data from the encrypted image data in the storage part 61, based on the ID information of the image data. Then, the data management part 621 identifies the output destination MFP based on the output destination information that is associated with the acquired encrypted image data, and sends the encrypted image data to the output destination MFP. Furthermore, the data management part 621 sends encrypted image data to the proxy processing MFP in the proxy output processing.

The overall control part 622 controls each of the parts so that the file server 6 operates smoothly as a whole.

The network interface 63 includes control programs such as a network communication program, and establishes the connections with the MFPs 2-5, the management server 7 and the like with use of a communication protocol so as to send and receive encrypted image data and such.

4. Construction of the Management Server

The management server 7 includes a storage part 71, a control part 72, and a network interface 73, as well as a CPU, a RAM and the like which are not shown in figures.

The storage part 71 stores the private key and the public key of the management server 7. In the event of the proxy output processing, the public key is sent to the proxy processing MFP, and to the client MFP that requests the proxy output. Meanwhile, the private key is used when the management server 7 decrypts encrypted device identification information that is sent from the MFPs 2-5.

Also, the storage part 71 stores device identification information of a client MFP and device identification information of an proxy processing MFP when the proxy output processing is executed. Additionally, it is preferable that device identification information is removed from the storage part 71 after the proxy output processing in order to reduce the risk of device identification information of a client MFP and that of a proxy processing MFP being leaked.

The control part 72 includes a proxy destination determination part 721, a device identification information acquisition part 722, a decryption/encryption part 723, an output destination control part 724, an output destination determination part 725, and an overall control part 726. In the control part 72, functions of the parts 721-726 are performed when a program that is installed in a certain area secured in a storage medium of the computer system is read out on a RAM by the CPU to be executed, and cooperates with the OS.

The proxy destination determination part 721 receives detection result information from the output abnormality detection part of a client MFP. After recognizing the occurrence of the output abnormality based on the detection result information, the proxy destination determination part 721 determines the proxy processing MFP by executing the proxy destination determination processing. A detailed description of the proxy destination determination processing is described below.

When executing the proxy output processing, the device identification information acquisition part 722 gives the client MFP and the proxy processing MFP an instruction to send the device identification information of the MFPs after encrypting it with the public key.

The decryption/encryption part 723 decrypts encrypted device identification information sent from either a client MFP or a proxy processing MFP. Specifically, the decryption/encryption part 723 decrypts the encrypted device identification information with the private key that is read out from the storage part 71.

Also, the decryption/encryption part 723 decrypts encrypted image data that is sent from a client MFP with use of device identification information of the client MFP. Furthermore, the decryption/encryption part 723 encrypts the decrypted image data based on the device identification information of a proxy processing MFP.

The output destination control part 724 gives a proxy processing MFP an instruction to decrypt and output encrypted image data that has been sent.

The output destination determination part 725 executes the output destination determination processing upon receiving an instruction from the output destination change reception part 253. The output destination determination processing is part of the output destination change processing. During the output destination determination processing, the output destination determination part 725 finds an MFP that is suitable as a new output destination from the data management system 1, and determines the MFP as the new output destination. A detailed description of the output destination determination processing is provided below.

The overall control part 726 controls each of the parts so that the management server 7 operates smoothly as a whole.

The network interface 73 includes control programs such as a network communication program, and establishes the connections with the MFPs 2-5, the file server 6 and the like with use of a communication protocol so as to send and receive encrypted image data and encrypted device identification information.

(Operational Behavior of the Data Management System)

The following is a detailed description of the Operational behavior of the data management system of the first embodiment.

1. Data Input Processing

The data input processing starts when “save data” has been selected from the processing menu that is displayed on the liquid crystal panel of the operating part 21 of the MFP 2.

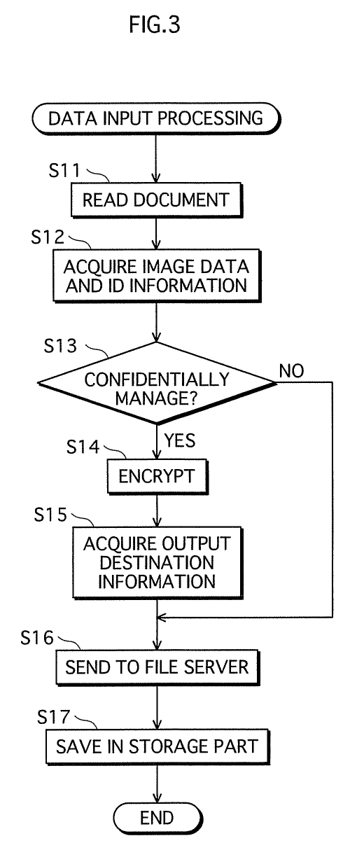

As shown in FIG. 3, a document is read in the reading part 22 first (step S11), and then image data and ID information regarding the image data are acquired (step S12).

When a user selects to manage the image data confidentially (“YES” in step S13), the decryption/encryption part 252 encrypts the image data based on the device identification information of the MFP 2 (step S14). Furthermore, the output destination information, which shows that the output destination of the image data is the MFP 2, is acquired (step S15). The image data that is acquired in the MFP 2 is encrypted based on the device identification information of the MFP 2. Basically, the image data that is encrypted based on the device identification information of the MFP 2 can be decrypted only by the MFP 2. Therefore, the output destination of the image data is usually the MFP 2.

In the case of selecting one of the MFPs 3-5 other than the MFP 2 as the output destination of the image data that is acquired in the MFP 2, it is conceivable that the image data acquired in the MFP 2 is sent to one of the MFPs 3-5 first, and then encrypted with the device identification information corresponding to the destination MFP where the image data is sent. When sending image data, it is preferable to add a security code to the image data or encrypt the image data in order to secure the confidentiality.

Then, the encrypted image data, the ID information and the output destination information are sent to the file server 6 (step S16). In the file server 6, the received encrypted image data is associated with the ID information and the output destination information to be stored in the storage part 61 (step S17).

Referring back to step S13, if a user does not select to manage image data confidentially (“NO” in step S13), the image data is sent to the file server 6 without being encrypted (step S16). Then, in the file server 6, the received image data is associated with ID information to be stored in the storage part 61 (step S17).

2. Data Output Processing

The data output processing starts when “data output” has been selected from the processing menu that is displayed on the liquid crystal panel of the operating part 21 of the MFP 2.

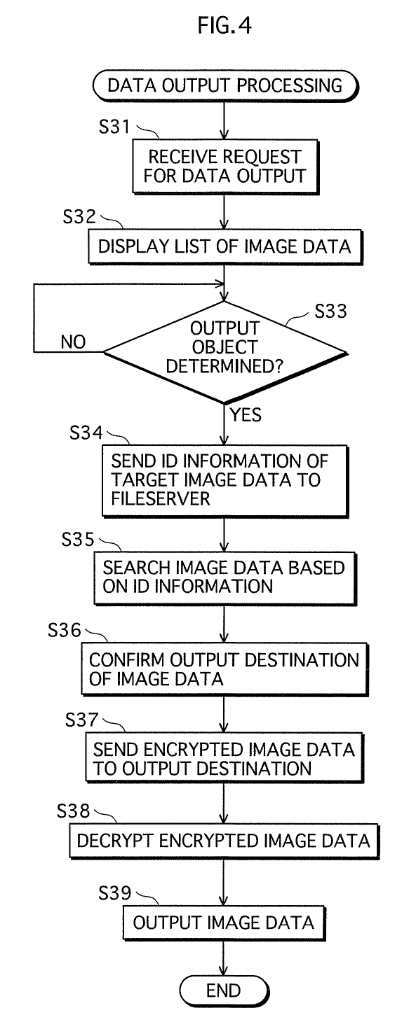

As shown in FIG. 4, when one of the MFPs (MFP 2 for example) receives a request for a data output (step S31), a list of image data stored in the data management system 1 is displayed on the liquid crystal panel of the operating part 21 (step S32). Then, when a user determines image data as an output object, (“YES” in step S33”), ID information of the image data is sent to the file server 6 (step S34).

In the file server 6 that has received the ID information, the data management part 621 searches image data in the storage part 61 by reference to the ID information (step S35). Furthermore, the data management part 621 confirms an output destination of image data by reference to output destination information associated with the image data (step S36).

When encrypted image data has been sent to an output destination MFP such as MFP 2 (step S37), the decryption/encryption part 252 of the MFP 2 decrypts the encrypted image data with use of the device identification information of the MFP 2 (step S38), and outputs the decrypted image data from the output part 23 (step S39).

3. Proxy Output Processing (General Outline)

In the data management system 1 of the first embodiment, if an output abnormality occurs in an output destination MFP, the following proxy output processing is executed.

The proxy output processing is executed in cases such as when a failure occurs in the output part of an output destination MFP, when jobs are accumulated in an output destination MFP, and when an output destination MFP is replaced by another MFP. The following describes the content of the proxy output processing with an example of when the MFP (B)3 executes the proxy output in order to output image data that is managed confidentially instead of the MFP(A)2 due to an output abnormality of the MFP(A)2.

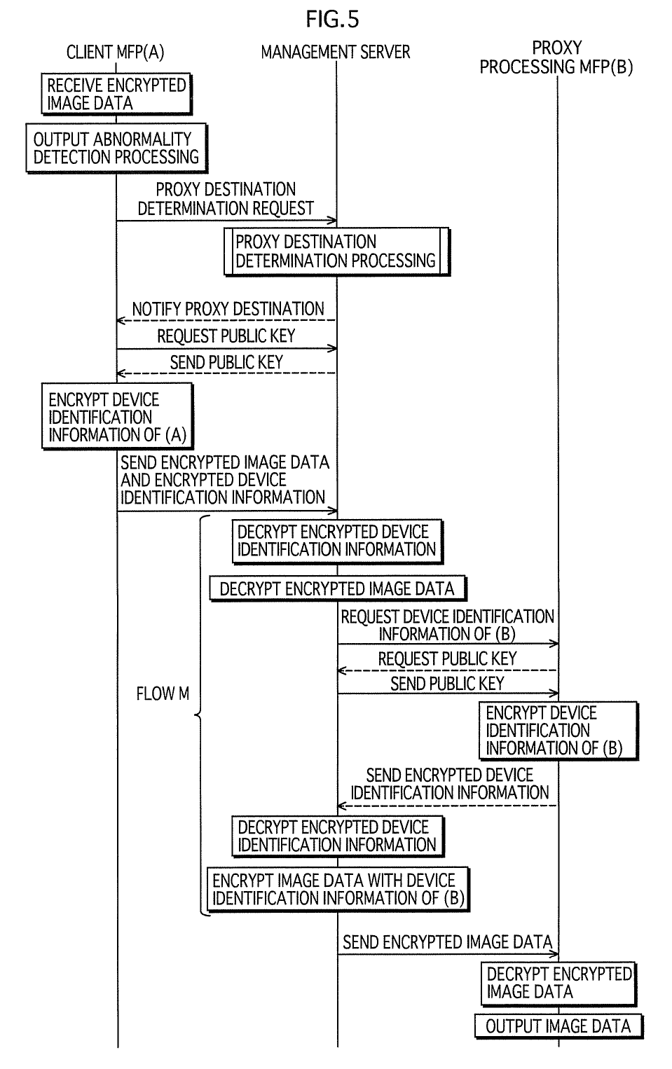

As shown in FIG. 5, when an output abnormality is detected in the MFP(A)2 that has received encrypted image data, the output abnormality detection part 251 of the MFP(A)2 requests the management server 7 to select a proxy processing MFP for outputting image data instead of the MFP(A)2.

The management server 7 that receives the request from the MFP(A)2 as a client MFP selects the MFP(B)3 as a proxy destination by executing the proxy destination determination processing, and notifies the MFP(A)2 about the result.

Upon receiving the notification, the MFP(A)2 requests the public key of the management server 7. The management server 7 sends the public key to the MFP(A)2 by accepting the request.

Upon receiving the public key, the MFP(A)2 encrypts the device identification information of the MFP(A)2 with the public key and sends the encrypted device identification information to the management server 7. Also, encrypted image data that was supposed to be output from the MFP(A)2 is sent to the management server 7 while still encrypted.

Upon receiving encrypted device identification information and encrypted image data, the management server 7 first decrypts the encrypted device identification information with the private key of the management server 7, and further decrypts the encrypted image data based on the acquired device identification information.

Next, the management server 7 requests device identification information of the MFP(B)3 from the MFP(B)3 as the proxy destination. By responding to the request, the MFP(B)3 requests a public key from the management server, and the management server 7 sends the public key to the MFP(B)3 by responding to the request. Upon receiving the public key, the MFP(B)3 encrypts the device identification information with the public key, and sends the encrypted device identification information to the management server 7.

After decrypting the encrypted device identification information with the private key of the management server 7, the management server 7 further encrypts the image data based on the device identification information of the MFP(B)3 and then sends the encrypted image data to the MFP(B)3.

The MFP(B)3 decrypts the received encrypted data with the device identification information of the MFP(B)3 and outputs the acquired image data.

4. Proxy Output Processing (Operational Behavior of a Client MFP)

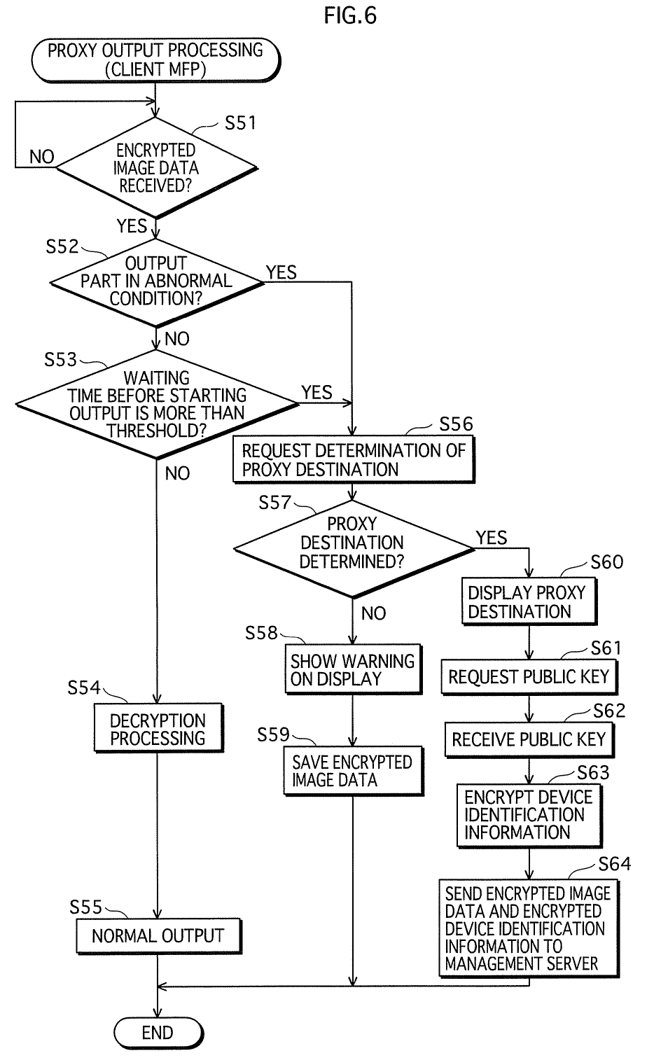

As shown in FIG. 6, when the client MFP(A)2 has received encrypted image data (“YES” in step 551), the output abnormality detection part 251 executes the output abnormality detection processing.

In the output abnormality detection processing, the output abnormality detection part 251 first determines whether or not the output part 23 is in an abnormal condition (step S52). If the determination shows that the output part 23 has no abnormalities (“NO” in step S52), the output abnormality detection part 251 determines whether the waiting time before starting the output is above a threshold (step 53).

When the determination has shown that the time is not above the threshold (“NO” in step S53), the decryption/encryption part 252 decrypts the encrypted image data based on the device identification information of the MFP(A)2 (step S54), and then the output part 23 outputs the decrypted image data in accordance with a normal, output processing (step S55).

Meanwhile in step S52, if the output abnormality detection part 251 determines that the output part 23 is in an abnormal condition (“YES” in step S52), and in step S53, if the determination has shown that the waiting time before starting the output is above the threshold (“YES” in step S53), the output abnormality detection part 251 requests the determination of the proxy destination from the management server 7 (step S58). Receiving the request for the determination of the proxy destination, the management server 7 executes the proxy determination processing. A detailed description of the proxy destination determination processing is provided below.

If the management server 7 cannot determine the proxy destination (“NO” in step S57), a warning is displayed on the liquid crystal display of the operating part 21 (step S58) to notify a user that the management server 7 cannot execute the proxy output. After saving the encrypted image data in the storage part 24 (step S59), the management server 7 finishes the processing and waits for the recovery from the output abnormality.

Referring back to step S57, if the management server 7 can determine the proxy destination (“YES” in step S57), the proxy destination MFP(B)3 to which the image data is output instead is shown on the liquid crystal panel of the operating part 21 (step S60) to notify a user the output destination of the image data.

After the MFP(A)2 requests for a public key from the management server 7 (step S61) and receives the public key (step S62), the MFP(A)2 encrypts the device identification information of the MFP(A)2 (step S63) and sends the encrypted device identification information and the encrypted image data to the management server 7 (step S64).

5. Proxy Output Processing (Operational Behavior of the Management Server)

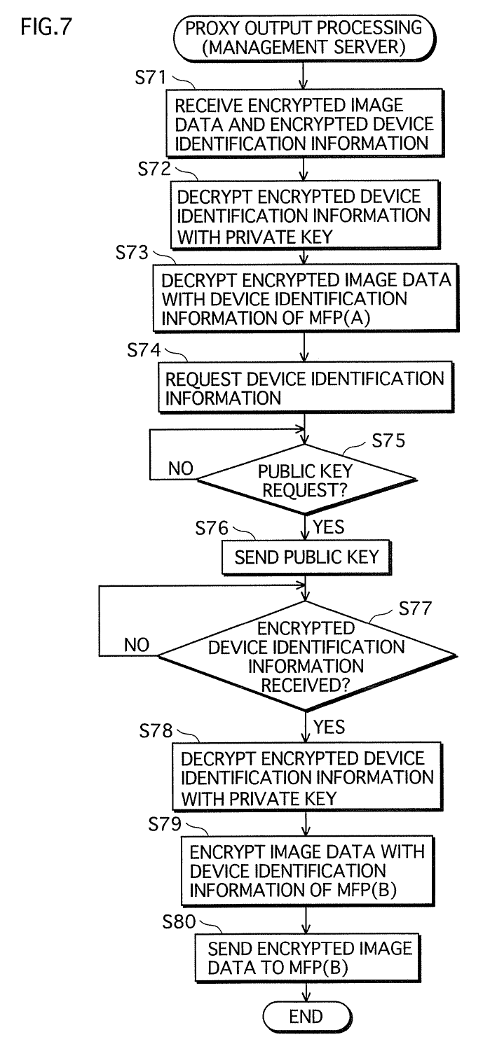

FIG. 7 shows the stages of the processing that are referred to as flow M in FIG. 5. As shown in FIG. 7, upon receiving the encrypted image data and the encrypted device identification information from MFP(A)2 (step S71), the management server 7 first decrypts the received encrypted device identification information with the private key of the management server 7. Furthermore, the management server 7 decrypts the encrypted image data based on the device identification information of the MFP(A)2 (step S73).

Next, the management server 7 requests the device identification information of the MFP(B)3 from the MFP(B)3, which has been selected as a proxy destination in the proxy destination determination processing (step S74). Upon receiving the request to send the public key from the MFP(B)3 in response (“YES” in step S75), the management server 7 sends the public key to the MFP(B)3 (step S76).

Upon receiving the encrypted device identification information that is encrypted with the public key (“YES” in step S77), the management server 7 decrypts it with the private key of the management server 7 (step S78), and then encrypts the image data based on the device identification information of the MFP(B)3 (step S79). Finally, the management server 7 sends the encrypted image data to the MFP(B)3 (step S80).

6. Proxy Destination Determination Processing

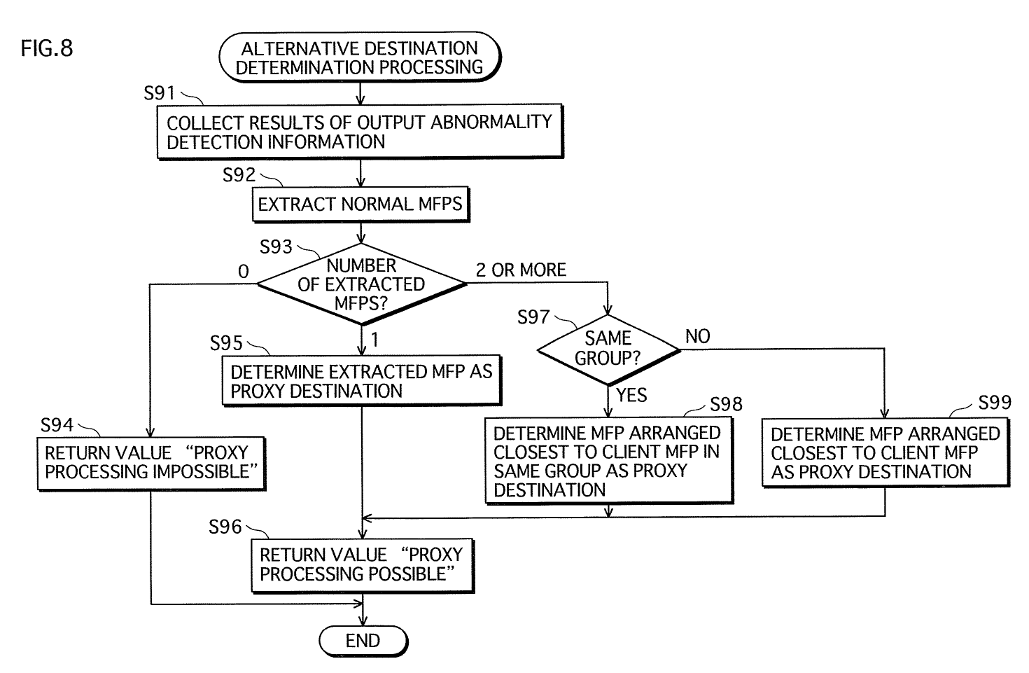

As shown in FIG. 8, in the proxy destination determination processing, the results of the output abnormality detection of all the MFPs 2-5 in the data management system 1 are collected (step S91). Specifically, the proxy destination determination part 721 of the management server 7 requests the output abnormality detection part of each of the MFPs 2-5 to send the detection result information and receives the detection result information therefrom.

Then, only the normal MFPs in which output abnormality has not been detected are extracted (step S92). Specifically, it is determined whether output abnormality has occurred or not in each of the MFPs 2-5 based on the detection result information sent from each of the MFPs 2-5, thereby extracting the MFPs in which output abnormality has not been detected.

Subsequently, the number of extracted MFPs is confirmed (step S93). If the number of extracted MFPs is “0” (“0” in step S93), a return value is set as “proxy processing impossible” (step S94) and the processing is terminated.

If the number of extracted MFPs is “1” (“1” in step S93), the extracted MFP is determined as a proxy destination (step S95). Then a return value is set as “proxy processing possible” (step S96) and the processing is terminated.

If the number of extracted MFPs is “2 or more” (“2 or more” in step S93), whether or not there is an MFP that belongs to the same management group as the client MFP is further determined (step S97).

If there are MFPs that belong to the same management group (“YES” in step S97), the MFP that is arranged closest to the client MFP among the MFPs in the same management group is determined as a proxy destination (step S98). Then, a return value is set as “proxy processing possible” (step S96) and the processing is terminated.

Referring back to step S97, if the MFP that belongs to the same management group does not exist (“NO” in step S97), the MFP that is arranged closet to the client MFP is determined as a proxy destination (step S99). Then, a return value is set as “proxy processing possible” (step S96) and the processing is terminated.

7. Output Destination Change Processing

In the data management system 1 of the first embodiment, in the case of changing the output destination of the image data saved in the data management system 1, the following output destination change processing is executed.

The output destination change processing is executed in cases such as when any of the MFPs in the data management system 1 is removed, when a new MFP is added to the data management system 1, and when an MFP is replaced by another MFP. The following describes the content of the output destination change processing with an example of when the output destination of image data saved in the data management system 1 is changed from the MFP(A)2 to the MFP(B)3.

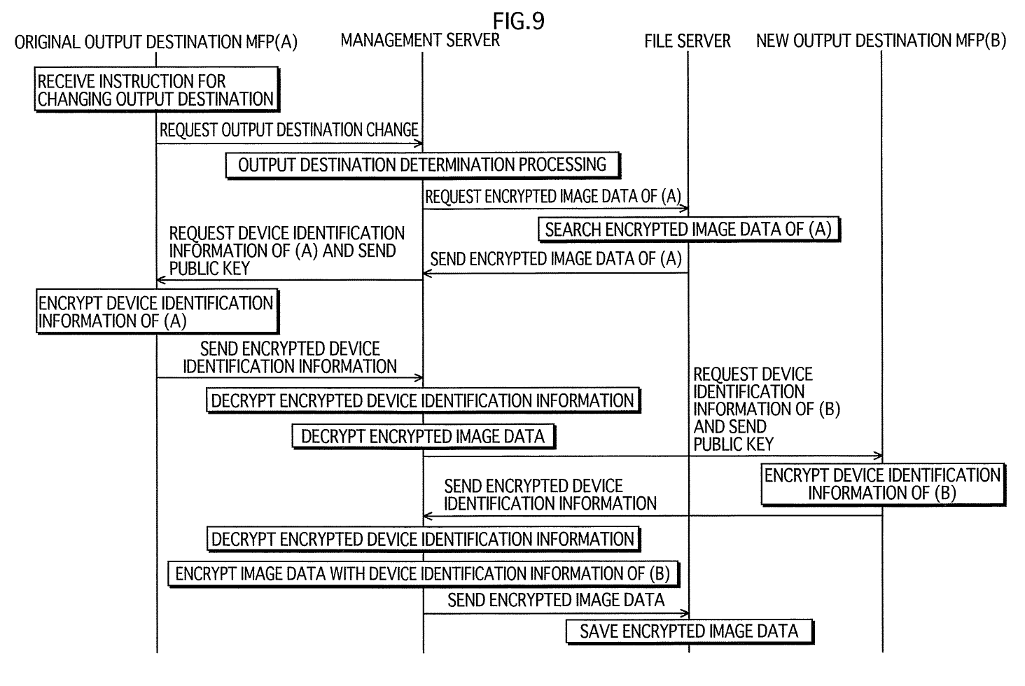

As shown in FIG. 9, the output destination change processing starts when “output destination change” has been selected from the processing menu that is displayed on the liquid crystal panel of the operating part 21 of the MFP(A)2.

When a user selects “output destination change” and also inputs the original output destination of the target image data, the MFP(A)2 for example, the output change destination reception part 252 receives an instruction for changing the output destination.

Upon receiving the instruction, the output destination change reception part 253 requests a change of the output destination from the management server 7. Accepting the request, the output destination determination part 725 in the management server 7 executes the output destination determination processing to determine a new output destination such as the MFP(B)3.

In the output destination determination processing, the output destination determination part 725 first determines whether or not there are any MFPs that belong to the same management group as the MFP(A)2. Then, if there are MFPs that belong to the same management group, the MFP that is arranged closest to the client MFP among the MFPs in the same management group is determined as a new output destination. Meanwhile, if the MFP that belongs to the same management group does not exist, the MFP that is arranged closet to the client MFP is determined as a new output destination.

It should be noted that the output destination determination part 725 is not always necessary for the data management system 1 of the present embodiment; therefore, the output destination determination part 725 may not be included therein. In such cases, when a user selects “output destination change” for example, the user may specify an MFP as a new output destination.

The management server 7 requests the file server 6 to send encrypted image data of the MFP(A)2. The data management part 621 of the file server 6 searches the encrypted image data whose output destination is specified as the MFP(A)2, from the encrypted image data saved in the storage part 61, based on output destination information. Then, the data management part 621 sends the acquired encrypted image data of the MFP(A)2 to the management server 7.

Next, the management server 7 requests device identification information of the MFP(A)2 from the MFP(A)2, and also sends the public key of the management server 7 to the MFP(A)2. Upon receiving the public key, the MFP(A)2 encrypts the device identification information of the MFP(A)2 with the public key and sends the encrypted device identification information to the management server 7.

Upon receiving the encrypted device identification information, the management server 7 first decrypts the encrypted device identification information with the private key of the management server 7, and further decrypts the encrypted image data of the MFP(A)2 based on the acquired device identification information.

Next, the management server 7 requests device identification information of the MFP(B)3 from the MFP(B)3 as a new output destination, and also sends the public key of the management server 7 to the MFP(B)3. Upon receiving the public key, the MFP(B)3 encrypts the device identification information of the MFP(B)3 with the public key, and sends the encrypted device identification information to the management server 7.

After decrypting the encrypted device identification information with the private key of the management server 7, the management server 7 further encrypts the image data based on the device identification information of the MFP(B)3. Then, the management server 7 sends the acquired encrypted image data to the file server 6.

Upon receiving the encrypted image data, the file server 6 saves the encrypted image data in the storage part 61.

(Summary)

In one aspect of the data management system of the first embodiment, a data management system in which a plurality of terminal devices are connected via a network, the data management system being for encrypting management object data and storing the encrypted management object data, and for outputting the management object data from an output part of any one of the plurality of terminal devices that is capable of decryption, the data management system comprises: an output abnormality detection part for detecting an output abnormality occurring in the any one of the terminal devices specified for outputting the management object data; a proxy destination determination part for, when the output abnormality detection part detects the output abnormality, determining a proxy processing terminal device from among the plurality of terminal devices, the proxy processing terminal device being for outputting the stored management object data instead of the terminal device having the output abnormality; and a decryption/encryption part for, when the proxy destination determination part has determined the proxy processing terminal device, decrypting the encrypted management object data that has been generated by encrypting the management object data, and further encrypting the resultant decrypted management object data to obtain resultant encrypted management data that is decryptable by the proxy processing terminal device.

In the above-described embodiment, the plurality of terminal devices may be image forming apparatuses, and the output abnormality detection part may detect the output abnormality caused by a failure of the output part of the terminal device capable of decryption. With this construction, even though a failure occurs in the output part of the predetermined terminal device, it is possible to output encrypted management object data that is encrypted in a manner that only the predetermined terminal device can encrypt it.

Also, the output abnormality detection part may detect the output abnormality caused by the output part of the terminal device capable of decryption being unable to start outputting the management object data for more than a predetermined time. With this construction, even when the management object data cannot be output from the predetermined terminal device immediately, another terminal device can output the data immediately.

Furthermore, one of the plurality of terminal devices may be a management sever, and the terminal device that is the management server may have the decryption/encryption part. With this construction, the management server intervenes between the sending and receiving of management object data conducted between terminal devices, and executes decryption and encryption instead of the terminal devices. Therefore, information that is necessary for decryption and encryption is not leaked to other terminal devices.

Still further, the plurality of terminal devices may each include the decryption/encryption part. With this construction, it is not necessary to prepare another device for encryption and decryption of management object data, resulting in a cost reduction of the data management system and simplification of the proxy output processing.

Yet further, the management object data may be encrypted based on device identification information of the terminal device specified as the output destination. This construction makes it difficult for terminal devices except the one specified as the output destination to decrypt encrypted data, resulting in higher confidentiality of data.

Also, the device identification information may be the information unique to each terminal device. With this construction, device identification information of each terminal device is hardly ever leaked out, resulting in even higher confidentiality of data.

### Second Embodiment

(Construction of Data Management System)

The following is a detailed description of the construction of the data management system of the second embodiment.

The data management system of the second embodiment is remarkably different from the data management system 1 of the first embodiment on the point that the management system of the second embodiment does not include the file server 6 and the management server 7. In the data management system of the second embodiment, MFPs perform the functions of the file server 6 in collaboration, and each MFP performs functions of the management server 7 individually.

In the data management system 1 of the first embodiment, data is encrypted based on a serial number of a storage part. However, in a data management system of the second embodiment, data is encrypted with use of a public key encryption method.

1. Overall Construction of the Data Management System

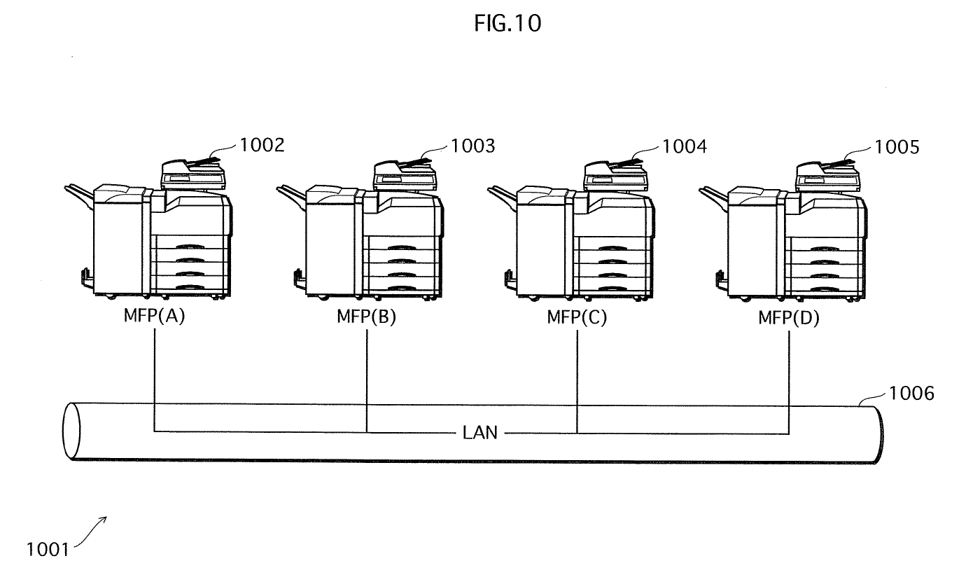

As shown in FIG. 10, the data management system 1001 of the present embodiment includes MFPs 1002-1005 as terminal devices, which are each connected via a network 1006.

2. Construction of each MFP

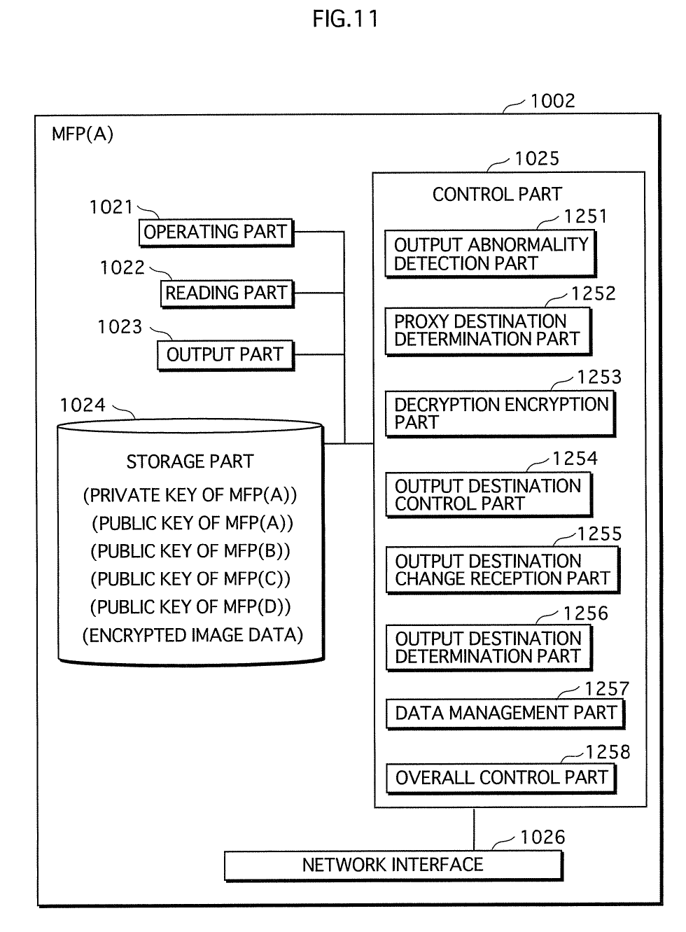

The following describes the constructions of the MFPs 1002-1005 with the MFP 1002 as an example. As shown in FIG. 11, the MFP 1002 includes an operating part 1021, a reading part 1022, an output part 1023, a storage part 1024, a control part 1025, and a network interface 1026, as well as a CPU, a RAM and the like which are not shown in figures.

Descriptions of the constructions of the operating part 1021, the reading part 1022, the output part 1023 and the network interface 1026 are omitted since the descriptions are substantially the same as the descriptions of the operating part 21, the reading part 22, the output part 23 and the network interface 26 of the first embodiment.

The storage part 1024 is an HDD, and stores the private key of the MFP 1002 and the public keys of the MFPs 1002-1005.

Also, the storage part 1024 stores image data acquired from the reading part 1022 of the MFP 1002 and image data received from the other MFPs 1003-1005. The image data is encrypted with the public key of one of the MFPs 1002-1005, and also associated with ID information of the image data and the output destination information that shows the output destination of the image data.

The control part 1025 includes an output abnormality detection part 1251, a proxy destination determination part 1252, a decryption/encryption part 1253, an output destination control part 1254, an output destination change reception part 1255, an output destination determination part 1256, a data management part 1257, an overall control part 1258 and the like. In the control part 1025, functions of the parts 1251-1258 are performed when a program that is installed in a certain are a secured in a storage medium of the computer system is read out on a RAM by the CPU to be executed, and cooperates with the OS.

The output abnormality detection part 1251 detects an output abnormality of the MFP 1002 by executing the output abnormality detection processing. The meaning of the output abnormality and a method for determining an output abnormality is substantially the same as the first embodiment.

The output abnormality detection processing is executed either before or after encrypted image data is decrypted in an output destination MFP, and determined whether or not the image data can be output from the MFP. A result of the detection is sent to a client MFP as detection result information. Also, the output abnormality detection processing is executed in response to a request from the proxy destination determination part of the client MFP. A result of the detection is sent to the client MFP as detection result information.

The proxy destination determination part 1252 receives the detection result information from the output abnormality detection part of the client MFP. After recognizing the occurrence of the output abnormality from the detection result information, the proxy destination determination part 1252 determines the proxy destination MFP.

The decryption/encryption part 1253 encrypts and decrypts image data. Image data is encrypted when a user has selected to manage the image data confidentially. When the image data has been selected to be managed confidentially, the public key of the output destination MFP is read out from the storage part 1024 so that the image data can be encrypted with the public key.

Furthermore, the decryption/encryption part 1253 decrypts encrypted image data with the private key of the MFP 1002. Encrypted image data that is encrypted with the public key of the MFP 1002 can only be decrypted with the private key of the MFP 1002. The private key of the MFP 1002 is held only by the MFP 1002, and cannot be acquired by other MFPs 1003-1005.

The output control part 1254 gives an output destination MFP to decrypt and output sent encrypted image data.

The output destination change reception part 1255 receives a request to change the output destination of image data to be stored in the data management system 1001. The request is input by a user operating the operating part 1021.

The output destination determination part 1256 executes the output destination determination processing, accepting the request from the output destination change reception 1255. The content of the output destination determination processing of the present embodiment is substantially the same as that of the first embodiment.

The data management part 1257 stores received encrypted image data in the storage part 1024 in the data input processing. Also, when an output destination MFP requests for encrypted image data during the data output processing, the data management part 1257 sends the encrypted image data to the output destination MFP. Specifically, the data management part 1257 searches the target encrypted image data from encrypted image data in the storage part 1024, based on ID information of the image data. Then, the data management part 1257 identifies the output destination MFP based on the output destination information that is associated with the acquired encrypted image data, and sends the encrypted image data to the output destination MFP. Furthermore, the data management part 1257 sends encrypted image data to the proxy processing MFP in the proxy output processing.

The overall control part 1258 controls each part of the MFP 2 so that the MFP operates smoothly as a whole.

The network interface 1026 includes control programs such as a network communication program, and establishes the connections with the MFPs 1003-1005 with use of a communication protocol so as to send and receive encrypted image data and such.

The descriptions of the MFPs 1003-1005 are omitted here since the constructions thereof are substantially the same as the MFP 1002.

(Operational Behavior of the Data Management System)

The following describes the operational behavior of the data management system of the second embodiment, focusing on differences from the operational behavior of the data management system of the first embodiment.

1. Data Input Processing

The data input processing of the second embodiment is different from that of the first embodiment on the point that encrypted image data and the like are saved in one of the MFPs, instead of the file server 6. Descriptions of all other points are simplified since they are substantially the same as the data input processing of the first embodiment, and a detailed description is only provided for the difference.

As shown in steps S16 and S17 of FIG. 3, in the data input processing of the first embodiment, encrypted image data, ID information, and output destination information are sent to the file server 6 to be stored in the storage part 61 of the file server 6. In contrast, in the data output processing of the second embodiment, encrypted image data, ID information, and output destination information are stored in one of the storage parts of the MFPs 1002-1005 in the data management system 1001. In other words, encrypted image data and the like are stored in either the storage part 1024 of the MFP 1002 that has acquired the encrypted image data or one of the storage parts of other MFPs 1003-1005.

2. Data Output Processing

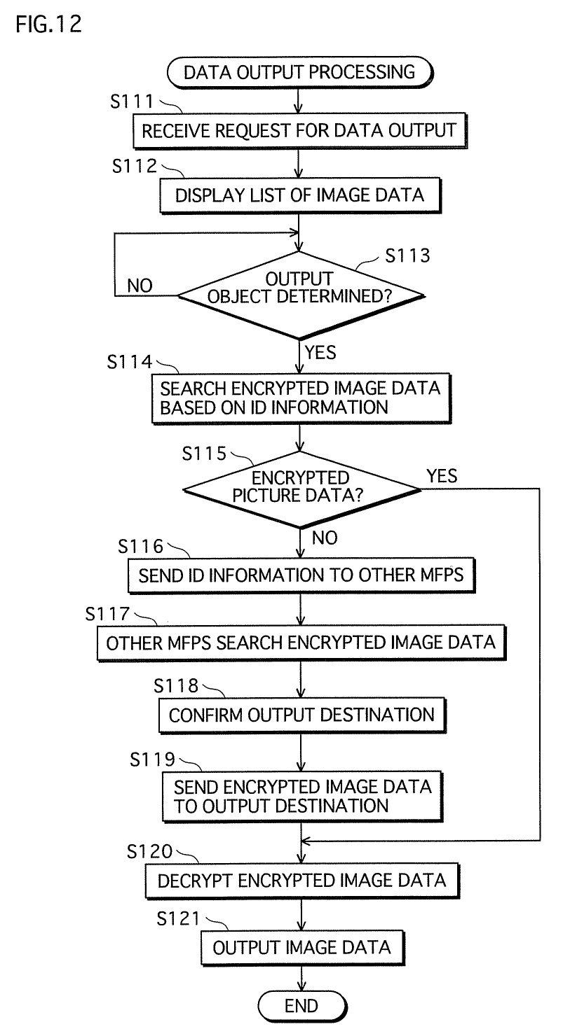

As shown in FIG. 12, when one of the MFPs (MFP 1002 for example) receives a request for a data output (step S111), a list of image data stored in the data management system 1 is displayed on the liquid crystal panel of the operating part 1021 (step S112). Then, when a user determines image data as an output object, (“YES” in step S113”), the data management part 1257 searches the image data from the image data stored in the storage part 1024 of the MFP 1002 by reference to the ID information (step S114).

If the target image data is not stored in the storage part 1024 of the MFP 1002 (“NO” in step S115), the data management part 1257 sends the ID information to other MFPs 1003-1005 (step S116). Upon receiving the ID information, the data management parts of the MFPs 1003-1005 searches for the target image data from the respective storage parts by reference to the ID information (step S117). Furthermore, the data management parts of the MFPs 1003-1005 confirm the output destination of the image data based on the output destination information associated with the image data (step S118).

After encrypted image data is sent to an output destination MFP such as the MFP 1003 (step S119), the decryption/encryption part of the MFP 1003 decrypts the encrypted image data with the private key of the MFP 1003 (step S120), and then the output part of the MFP 1003 outputs the decrypted image data from the output part of the MFP 1003 (step 121).

Referring back to step S115, if the target image data is stored in the storage part 1024 of the MFP 1002 (“YES” in step S115), the decryption/encryption part 1253 decrypts the encrypted image data with the private key of the MFP 1002 (step S120), and the output part 1023 outputs the decrypted image data (step S121).

3. Proxy Output Processing

In the data management system 1001 of the second embodiment, if an output abnormality occurs in an output destination MFP, the following proxy output processing is executed.

The proxy output processing is executed in cases such as when a failure occurs in the output part of an output destination MFP, when print jobs are accumulated in an output destination MFP, and when an output destination MFP is replaced by another MFP. The following describes the proxy output processing of the second embodiment, with an example of when the MFP(B)1003 executes the proxy output in order to output image data that is managed confidentially instead of the MFP(A)1002 due to an output abnormality of the MFP(A)1002.

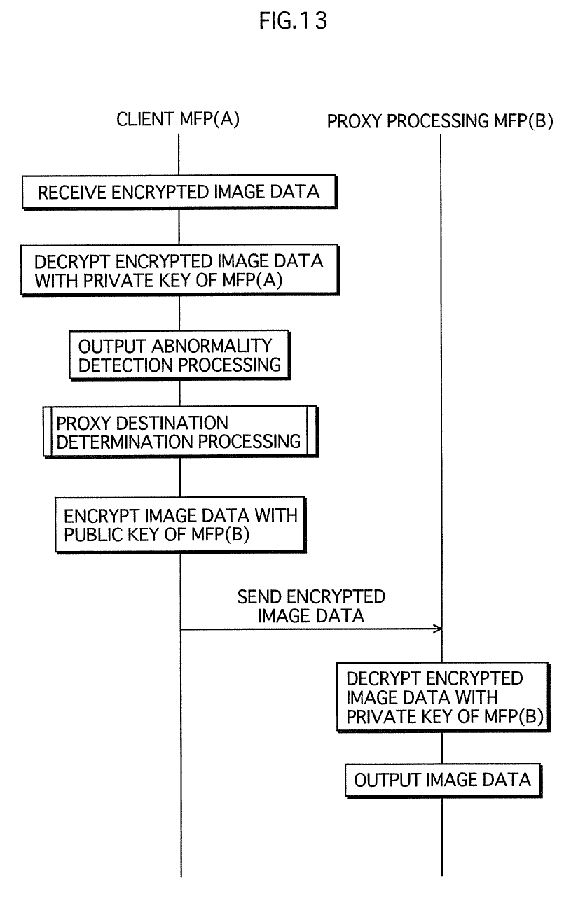

As shown in FIG. 13, upon receiving encrypted image data, the MFP(A) 1002 decrypts the encrypted image data with the private key of the MFP(A)1002.

Next, the output abnormality detection part 1251 executes the output abnormality detection processing. The content of the output abnormality detection processing is substantially the same as that of the first embodiment.

If an output abnormality has been detected, the proxy destination determination processing is executed. The content of the proxy destination determination processing is substantially the same as that of the first embodiment.

After the MFP(B)1003 has been selected as a proxy processing MFP during the proxy destination determination processing, the decryption/encryption part 1253 of the MFP(A)1002 encrypts image data with the public key of the MFP(B)1003 that is stored in the storage part 1024. Then, the encrypted image data is sent to the MFP(B)1003.

Upon receiving the encrypted image data, the decryption/encryption part of the MFP(B)1003 decrypts the encrypted image data with the private key of the MFP(B)1003, and then outputs the decrypted image data from the output part of the MFP(B)1003.

4. Output Destination Change Processing

In the data management system 1001 of the second embodiment, in the case of changing the output destination of image data, stored in the data management system 1001, the following output destination change processing is executed.

The output destination change processing is executed in cases such as when any of the MFPs in the data management system 1001 is removed, when a new MFP is added to the data management system 1001, and when an MFP is replaced by another MFP. The following describes the content of the output destination change processing with an example of when the output destination of image data saved in the data management system 1001 is changed from the MFP(A)1002 to the MFP(B)1003.

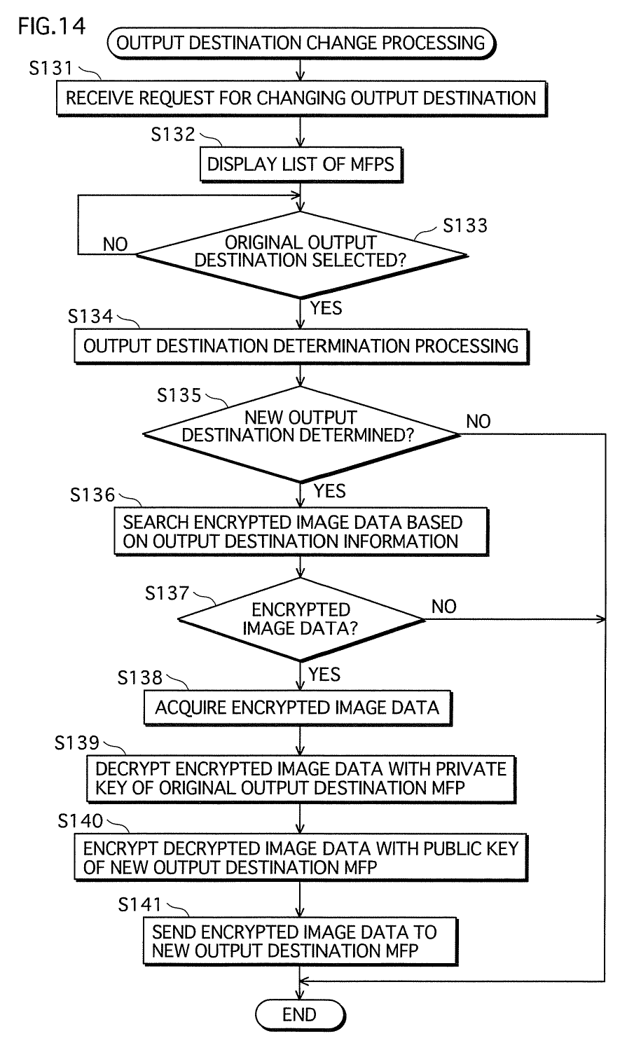

As shown in FIG. 14, when an output destination change reception part 1255 of an MFP (MFP(A) 1002, for example) receives a request for changing the output destination (step S131), a list of the MFPs 1002-1005 that is stored in the data management system 1001 is displayed on the liquid crystal panel of the operating part 1021 (step S132).

When a user selects the original output destination MFP such as the MFP(A)1002 (“YES” in step S133), the output destination determination part 1256 executes the output destination determination processing to determine a new output destination MFP such as MFP(B) 1003 (step S134). The description of the content of the output destination determination processing is omitted since it is substantially the same as the content of the output destination determination processing of the first embodiment.

When a new output destination has been determined (“YES” in step S135), image data that is encrypted with the public key of the MFP(A)1002 is searched from the image data stored in the data management system 1001 (step S136). Specifically, the data management part 1257 of the MFP(A) 1002 inquires of all the MFPs 1002-1005 in the data management system 1001 whether or not the storage parts of the MFPs 1002-1005 store image data that is encrypted with the public key of the MFP(A) 1002. Upon receiving the inquiry, the MFPs 1002-1005 search the image data that is encrypted with the public key of the MFP(A)1002 from the encrypted image data stored in the respective storage parts, by reference to output destination information.

If the encrypted image data is stored in a storage part of one of the MFPs 1002-1005 (“YES” in step S137), the MFP(A)1002 requests the one of the MFPs 1002-1005 to send the encrypted image data, and acquires the encrypted image data of the MFP(A)1002 (step S138).

Next, the decryption/encryption part 1253 of the MFP(A) 1002 decrypts the acquired encrypted image data with the private key of the MFP(A)1002 (step S139). Furthermore, the MFP(A)1002 encrypts the decrypted image data with the public key of the MFP(B) 1003 (step S140) and sends the encrypted image data to the MFP(B) 1003 (step S141). Upon receiving the encrypted image data, the MFP(B) 1003 stores it in the storage part of the MFP(B)1003.

Referring back to step S135, if a new output destination cannot be determined (“NO” in step S135), the output destination change processing is terminated without the output destination being changed.

Referring back to step S137, if image data encrypted with the public key of the MFP(B) 1002 does not exist in the data management system 1001 (“NO” in step S137), the output destination change processing is terminated without the output destination being changed.

(Summary)

In one aspect of the data management system of second embodiment, a data management system in which a plurality of terminal devices are connected via a network, the data management system being for encrypting management object data and storing the encrypted management object data, and for outputting the management object data from an output part of any one of the plurality of terminal devices that is capable of decryption, the data management system comprises: an output destination change reception part for receiving an instruction to change a terminal device specified as an output destination of the management object data; and a decryption/encryption part for, when the output destination change reception part has received the instruction to change the terminal device, decrypting the encrypted management object data that has been encrypted in a manner that the terminal device specified as an original output destination can decrypt the management object data, and further encrypting the resultant decrypted management object data to obtain resultant encrypted management object data that is decryptable by a terminal device specified as a new output destination.

The above-described embodiment may include an output destination determination part for determining the terminal device for the new output destination, when the output destination change reception part has received the instruction to change the terminal device. With this construction, an output destination change can be executed without a user specifying a new output destination.

Also, the plurality of terminal devices may each include the decryption/encryption part. With this construction, it is not necessary to prepare another device for encryption and decryption of management object data, resulting in a cost reduction of the data management system and simplification of the proxy output processing.

<Modifications of Data Management System>

Although the data management system according to one construction of the present embodiment has been described specifically based on the embodiments outlined above, the scope of the present invention is not of course limited to the above-described embodiment.

For example, the terminal devices are not limited to MFPs, and may be PCs, printers, photocopiers, facsimile machines, or the like. Also, the number of terminal devices is not limited to the above-described number, and is acceptable as long as the number of terminal devices is two or more. Furthermore, the number of file servers is not limited to one, and the number thereof may be more than one. Also, it is acceptable to have a construction in which a file server serves as a management server.

The data is not limited to image data, and may be audio data. Also, the image data may include not only data regarding diagrams and tables, but also character data as well as data combined with diagrams, tables and characters.

The output parts are not limited to printer parts, and may be monitor parts that display image data. In other words, data output includes cases when data is displayed on a screen as well as when data is output on a sheet of paper as printed matter. Furthermore, the output parts may be speaker parts that output audio data.

The encryption keys are not limited to the keys used in a public key encryption method, and may be the keys used in a secret key encryption method. It is conceivable that ElGamal encryption, an elliptic curve cryptosystem and such are adopted for the public key encryption method, and Triple DES, FEAL, Ri jndael, MISTY and such are adopted for the secret key encryption method, based on encryption strength, encryption speed and the like. It should be noted that the encryption keys may be changed regularly.

<Data Management Method>

The present invention is not limited to the data management system and may be the data management method. Furthermore, the method may be a program executed by a computer. Also, the program of the present invention can be recorded onto a computer-readable recording medium such as (i) a magnetic disk including a magnetic tape, a flexible disk and the like, (ii) an optical recording medium including a DVD-ROM, a DVD-RAM, a CD-ROM, a CD-R, an MO and a PD, (iii) a flash memory-type recording medium. The program may be manufactured and provided in the form of a recording medium. The program may also be transmitted and provided in the form of a program via a wired or wireless network including the Internet, broadcast, a telecommunication circuit, and satellite communication.

Also, the above-described program does not need to include all the modules that enable a computer to execute the above-described processing. It is acceptable that a computer executes the processing with use of general programs such as a communication program and a program included in an OS, which can be installed on an information processing device separately. Therefore, the above-described recording medium does not always need to store the record of all the modules described above. Also, it is not always necessary to transmit all the modules to a computer. Furthermore, predetermined processing may be executed with use of dedicated hardware.

Although the present invention has been fully described by way of examples with reference to the accompanying drawings, it is to be noted that various changes and modifications will be apparent to those skilled in the art.

Therefore, unless otherwise such changes and modifications depart from the scope of the present invention, they should be construed as being included therein.

What is claimed is:

1. A data management system in which a plurality of terminal devices are connected via a network, the data management system being for encrypting management object data and storing the encrypted management object data, and for outputting the management object data from an output part of any one of the plurality of terminal devices that is capable of decryption, the data management system comprising:
an output abnormality detection part for detecting an output abnormality occurring in the any one of the terminal devices specified for outputting the management object data;
a proxy destination determination part for, when the output abnormality detection part detects the output abnormality, determining a proxy processing terminal device from among the plurality of terminal devices, the proxy processing terminal device being for outputting the stored management object data instead of the terminal device having the output abnormality; and
a decryption/encryption part for, when the proxy destination determination part has determined the proxy processing terminal device, decrypting the encrypted management object data that has been generated by encrypting the management object data, and further encrypting the resultant decrypted management object data to obtain resultant encrypted management data that is decryptable by the proxy processing terminal device.

2. The data management system of claim 1, wherein
the plurality of terminal devices are image forming apparatuses, and
the output abnormality detection part detects the output abnormality caused by a failure of the output part of the terminal device capable of decryption.

3. The data management system of claim 1, wherein
the output abnormality detection part detects the output abnormality caused by the output part of the terminal device capable of decryption being unable to start outputting the management object data for more than a predetermined time.

4. The data management system of claim 1, wherein
one of the plurality of terminal devices is a management sever, and
the terminal device that is the management server has the decryption/encryption part.

5. The data, management system of claim 1, wherein
the plurality of terminal devices each include the decryption/encryption part.

6. The data management system of claim 1, wherein
the management object data is encrypted based on device identification information of the terminal device specified as the output destination.

7. The data management system of claim 6, wherein
the device identification information is the information unique to each terminal device.

8. A data management system in which a plurality of terminal devices are connected via a network, the data management system being for encrypting management object data and storing the encrypted management object data, and for outputting the management object data from an output part of any one of the plurality of terminal devices that is capable of decryption, the data management system comprising:
an output destination change reception part for receiving an instruction to change a terminal device specified as an output destination of the management object data; and
a decryption/encryption part for, when the output destination change reception part has received the instruction to change the terminal device, decrypting the encrypted management object data that has been encrypted in a manner that the terminal device specified as an original output destination can decrypt the management object data, and further encrypting the resultant decrypted management object data to obtain resultant encrypted management object data that is decryptable by a terminal device specified as a new output destination.

9. The data management system of claim 8, further comprising:
an output destination determination part for determining the terminal device for the new output destination, when the output destination change reception part has received the instruction to change the terminal device.

10. The data management system of claim 8, wherein
one of the plurality of terminal devices is a management sever, and
the terminal device that is the management server has the decryption/encryption part.

11. The data management system of claim 8, wherein
the plurality of terminal devices each include the decryption/encryption part.

12. The data management system of claim 8, wherein
the management object data is encrypted based on device identification information of the terminal device determined to be the output destination.

13. The data management system of claim 12, wherein
the device identification information is information unique to each terminal device.

14. A method of data management for encrypting management object data and storing the encrypted management object data, and for outputting the management object data from an output part of any one of the plurality of terminal devices that is capable of decryption, in a data management system in which the plurality of terminal devices are connected via a network, comprising the steps of:
detecting an output abnormality occurring in the any one of the terminal devices specified for outputting the management object data;
determining, when the output abnormality has been detected, a proxy processing terminal device from among the plurality of terminal devices instead of the terminal device having the output abnormality, the proxy processing terminal device being for outputting the management object data;
decrypting, when the proxy processing terminal device has been determined, the encrypted management object data that has been generated by encrypting the management object data, and further encrypting the resultant decrypted management object data to obtain resultant encrypted management object data that is decryptable by the proxy processing terminal device.

15. A method of data management for encrypting management object data and storing the encrypted management object data, and for outputting the management object data from an output part of any one of the plurality of terminal devices that is capable of decryption, in a data management system in which the plurality of terminal devices are connected via a network, comprising the steps of:
receiving an instruction to change the terminal device specified as an output destination of the management object data; and
decrypting, when the instruction to change the terminal device has been received, the encrypted management object data that has been encrypted in a manner that the terminal device specified as an original output destination can decrypt the management object data, and further encrypting the resultant decrypted management object data to obtain resultant encrypted management object data that is decryptable by a terminal device specified as a new output destination.
